(19) United States
(12) Patent Application Publication
(10) Pub. No.: US 2014/0307931 A1
(43) Pub. Date: Oct. 16, 2014

(54) FULLY AUTOMATED SYSTEM AND METHOD FOR IMAGE SEGMENTATION AND QUALITY CONTROL OF PROTEIN MICROARRAYS

(71) Applicant: Massachusetts Institute of Technology, Cambridge, MA (US)

(72) Inventors: Todd Michael Gierahn, Brookline, MA (US); Denis Loginov, Cambridge, MA (US); John Christopher Love, Somerville, MA (US)

(73) Assignee: Massachusetts Institute of Technology, Cambridge, MA (US)

(21) Appl. No.: 14/253,230

(22) Filed: Apr. 15, 2014

Related U.S. Application Data
(60) Provisional application No. 61/812,242, filed on Apr. 15, 2013.

(51) Int. Cl. G06T 7/00

(52) U.S. Cl. CPC G06T 7/0079
USPC 382/128

(57) ABSTRACT

A system for providing fully automated image segmentation and quality control of a protein array with no human interaction is presented. The system includes a memory and a processor configured by the memory. The processor is configured to receive an image file of the protein array, to geometrically distinguish a first block within the image, register a nominal location of the first block to the image by assigning a geometric code identifying the first block, draw a plurality of grid line on the array to delineate the first block from a second block, iteratively cluster a sub image for each feature in the delineated blocks to define a foreground area and a background area, identify pixels containing an artifact for each feature, and extract and return the signal intensity, variance, and quality of background and foreground pixels in each feature.

### CROSS-REFERENCE TO RELATED APPLICATIONS

This application claims the benefit of U.S. Provisional Patent Application Ser. No. 61/812,242, filed Apr. 15, 2013, entitled “FULLY AUTOMATED SYSTEM AND METHOD FOR IMAGE SEGMENTATION AND QUALITY CONTROL OF PROTEIN MICROARRAYS,” which is incorporated by reference herein in its entirety.

### STATEMENT REGARDING FEDERALLY SPONSORED RESEARCH OR DEVELOPMENT

This invention was made with government support under Grant Nos. AI068618 and AI104274 awarded by the National Institutes of Health. The government has certain rights in the invention.

### FIELD OF THE INVENTION

The present invention relates to protein array analysis, and more particularly, is related to extraction of accurate data from images of microengraved protein arrays.

### BACKGROUND OF THE INVENTION

Multiplexing biological assays on microarrays has been instrumental for generating the data required to understand biology at the systems-level. Although microarrays have played a large part in the exponential growth of biological data over the past decade, there remain bottlenecks in the use of this technology. A primary challenge is the accurate and expedient analysis of the images of the microarrays that contain the data. There are multiple commercial and open source software packages commonly used to analyze images of arrays, but these packages cannot automatically handle the types of distortions commonly observed in protein microarrays (e.g. loss of signal, comet tails, grid distortions, etc.). Often, considerable manual adjustments of an overlaid nominal grid are needed to align it properly to individual features of interest. Most software packages also provide few, if any, tools to identify artifacts in the images, thereby requiring a manual review of features after data analysis to ensure the quality of the data. This issue is a particular concern for protein microarrays as this technology is more sensitive than DNA microarrays to low amounts of spurious signal due to the typical lack of signal in the majority of features in the analyte channels, enabling a small amount of spurious signal to increase the measured intensity of feature above the positive threshold. Overall, manual segmentation and annotation not only cost hours of trained labor per array, but also introduce significant variability in data analysis among users. With the motivation to create ever larger datasets for systems-level analysis on clinical samples, these inefficiencies represent a significant barrier in efforts to understand human disease and mechanisms of action for interventions.

Numerous approaches have been proposed to extract information from images of microarrays by both semi-automated and fully-automated methods. Initial approaches used the user-defined specifications of the array and template matching to find the optimal alignment with the expected geometries. This approach was later expanded to allow adaptive deformation of the templates. Approaches using one dimensional (1-D) image projections with and without image filtering were also implemented for aligning grids to arrays. Clustering approaches used to segregate foreground and background pixels have proven to be some of the most successful approaches for identifying features. Other mathematical approaches have also been proposed, including seeded region growing, support vector machine (SVM), and mixture models, among others. Most implemented approaches rely heavily on a single approach. However, no single approach automatically handles the variety of aberrations that occur on experimentally produced arrays, especially protein-based arrays. Another approach combines the strengths of different methodologies in a logical way to create a hierarchical gridding algorithm that is more robust to a variety of aberrations common in protein microarrays. The availability of cheap computational power and parallelized processing enables the implementation of multiple approaches to registering and aligning features on the same array within a reasonable processing time.

The increase in computing power also allows a more in-depth analysis of the signal in the image, enabling the de-convolution of true signal and artifact prior to the extraction of data. Multiple approaches have been proposed to qualify data extracted from microarrays, but most rate the reliability of each data point using metrics assigned after the initial extraction of data (e.g. covariance (CV), signal-to-noise ratio (SNR)). Far more information is encoded in the image itself, particularly at the granularity of the location and intensity of individual pixels. Robust analysis of the image prior to data extraction may yield a more accurate description of the artifacts present, and thus enable their removal, yielding more accurate and reliable data than qualification of data after extraction. Techniques for identifying artifacts in images of microarrays previously implemented include clustering pixels into more than two groups to identify and remove outlier pixels, and a geometric comparison of bright pixels to a feature template. These approaches, however, can miss artifacts that overlap the template or that have intensities similar to the true signal. Therefore, there is a need in the industry to address at least some of the abovementioned shortcomings.

### SUMMARY OF THE INVENTION

Embodiments of the present invention provide a fully automated system and method for image segmentation and quality control of protein arrays. Briefly described, the present invention is directed to a system for providing fully automated image segmentation and quality control of a protein array with no human interaction. The system includes a memory and a processor configured by the memory. The processor is configured to receive an image file of the protein array, to geometrically distinguish a first block within the image, register a nominal location of the first block to the image by assigning a geometric code identifying the first block, draw a plurality of grid line on the array to delineate the first block from a second block, iteratively cluster a sub image for each feature in the delineated blocks to define a foreground area and a background area, identify pixels containing an artifact for each feature, and extract and return the signal intensity, variance, and quality of background and foreground pixels in each feature.

A second aspect of the present invention is directed to a system for adaptively assigning positions of blocks in a protein array image to monitor distortions and/or ignore spurious and missing signals in parts of the protein array image, having a memory, and a processor. The processor is configured by the memory to apply a bandpass filter to the array image to emphasize the vertical or horizontal inter-block signals, use a first one dimensional projection along an axis perpendicular to the emphasized signal to monitor the inter-block signals of a predetermined number of pixels, align the first one dimensional projection with a template projection, reject overlapping signals, assign a grid score, and match a seeded signal to a second one dimensional projection.

Briefly described, in architecture, a third aspect of the present invention is directed to a system for identifying and removing artifacts within a plurality of feature sub images of a protein array image, including a memory and a processor. The processor is configured by the memory to identify structured pixels in each feature sub image by applying k-means clustering to identify pixel clusters in the foreground and background of each feature and applying a connectivity image transformation. The processor may order the clusters from brightest to dimmest, and start at the brightest cluster and proceed progressively toward the dimmest cluster. The processor may change the value of positive pixels to a connectivity value of the pixels, wherein the connectivity value of a pixel may include a sum of adjacent positive pixels including itself.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic outline of a first exemplary protein array analysis method.

FIG. 2A is a diagram illustrating rotation and registration of a protein array image, and in particular, three images of radon integrating vectors at three discrete angles (−10, 0 and 10°) and the resulting radon transform of the image at those angles.

FIG. 2B is a plot of the sums of the absolute slope of the radon curve at each degree of rotation normalized to the highest value for that sample image as a function of the degree of rotation for 500 sub images sampled from the array of FIG. 2A.

FIG. 2C is a diagram showing the technique used to decipher the geometric code in each block.

FIG. 2D is a diagram indicating well score for each feature in the block (left array) and the cipher used to decode the block location (right panel).

FIG. 3A is a diagram showing application of a series of bandpass filters to a protein array image under the second embodiment.

FIG. 3B are plots of a deviation from the initial inter-block signal used for seeding as a function of the y position in the array.

FIG. 3C is a diagram showing final error correction in the block gridding procedure.

FIG. 3D is a diagram showing an example of a final overlay for the blocks in an array.

FIG. 3E is a flowchart illustrating the process under the second embodiment.

FIG. 4A is a sample image of a protein array image block with gridlines separating individual features.

FIG. 4B is an example of iterative clustering of the pixels in the boxed-feature.

FIG. 4C is a diagram of graphical representations of the kernels used in the convolution with the top cluster of FIG. 4A.

FIG. 4D is a graphical schematic of the process used to define the foreground and background of each feature of the image of FIG. 4A.

FIG. 5A show two grids (top) with examples of binary images and their connectivity transforms (bottom).

FIG. 5B shows plots of the expected fraction of positive pixels in a binary image with a particular connectivity value based on random noise as a function of the fraction of positive pixels in the image.

FIG. 5C shows examples of three types of images, their top ranked clusters determined by k-means clustering and the enrichment of connectivity values in each cluster relative to random noise.

FIG. 5D is a schematic diagram showing an exemplary process used to remove artifacts.

FIG. 6 is a decision tree used to define structured pixels within an image.

FIG. 7 is a text diagram illustrating the steps used to define structured pixels as an artifact or a real signal.

FIG. 8A is two plots of the feature SNR and background-subtracted median intensity generated by Genepix (top panel) or the present embodiment (bottom panel).

FIG. 8B is a plot of ROC curves generated by increasing the SNR cutoff using values generated by Genepix (bottom) or embodiments (top) from an image of a microengraved array.

FIG. 8C is a plot showing the distribution of SNR values of features that contained cells or were empty during microengraving.

FIG. 9 is a schematic diagram illustrating an example of a system for executing functionality of the present invention.

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

As noted above, no prior single approach automatically handles the variety of aberrations that occur on experimentally produced arrays, especially protein-based arrays. Exemplary embodiments disclosed herein combine the strengths of different methodologies in a logical way to create a hierarchical gridding process that is more robust to a variety of aberrations common in protein arrays and microarrays. The availability of cheap computational power and parallelized processing enables the implementation of multiple approaches to registering and aligning features on the same array within a reasonable processing time.

Exemplary embodiments disclose a fully automated process that can robustly and accurately analyze microengraved arrays containing significant aberrations. Microengraved arrays have several characteristics that make them difficult to automatically analyze using previously published approaches. The features may be small, for example, 30-50 μm, and densely packed, for example, 60-100 μm pitch. The typical signal intensity may be considerably lower than a typical DNA microarray, for example, on the order of 1.5-3 times, requiring sensitive methods for distinguishing signals. Although the elastomeric arrays are manufactured with high precision, the process of microengraving often distorts the lateral structure of the array and individual features in a non-uniform manner. The arrays are also very large, covering most of the surface area of a typical microscope slide, for example, with more than 80,000 features. Nonlinear distortions over large distances make approaches that rely on placing straight lines to delineate the array difficult to implement. The features are arranged in small blocks with, for example, 50-100 features/block, and a row or two of blocks may be missing from an edge of the array. This loss of features makes automatic registration of blocks impossible with prior art approaches. Each feature in a microengraved array represents a unique measurement, a fact that negates any approach that relies on replicate spots for quality control.

As described above, protein microarrays represent an important class of tool for evaluating protein-protein interactions and secretomes. Manual annotation of data extracted from images of such microarrays, however, has been a significant bottleneck, particularly due to the sensitivity of this technology to weak signals and artifact. To address this challenge, embodiments of the present system and method introduce functionality to automate the extraction and curation of data from protein microarrays. For exemplary purposes, at least a portion of this functionality is embodied in the present description as a process.

Embodiments of the present invention are presented to overcome the abovementioned specific problems associated with microengraved arrays and more general aberrations common to conventional spotted microarrays. Embodiments provide a hybrid process/functionality that combines a multi-faceted grid-aligning process with a versatile framework for identifying artifactual pixels within the image. Such embodiments greatly aid the application of microengraving technology to clinical samples as well as improving the quality of data extracted from conventionally spotted protein microarrays.

Embodiments logically combine information from multiple approaches for segmenting microarrays, yielding a fully automated protocol that is robust to significant spatial and intensity aberrations. Segmentation is followed by a novel artifact removal process that segregates structured pixels from the background noise using iterative clustering and pixel connectivity and then using correlation of the location of structured pixels across image channels to identify and remove artifact pixels from the image prior to data extraction. Application of this process to protein microarrays of single-cell secretomes created by microengraving yields higher quality data than that produced from a common commercial software tool, with the average time required for user input reduced from hours to minutes. This increase in throughput is desirable for further implementation of protein microarrays as tools in clinical studies where robust and invariant protocols are necessary.

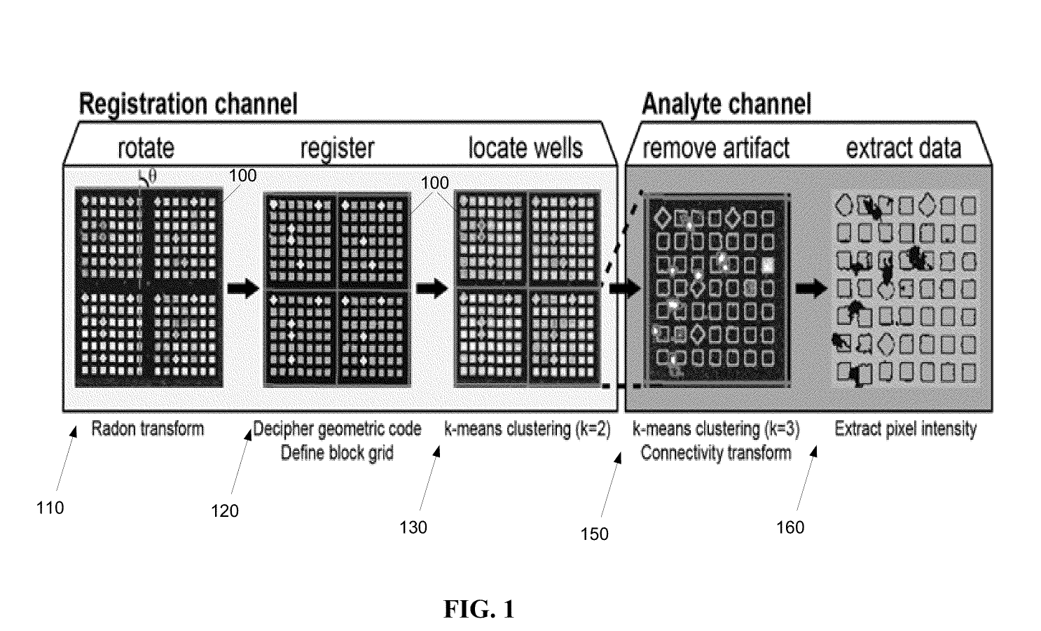

A first exemplary embodiment of the present invention may be implemented as an integrated software package run on a computer (as identified below) that receives as input a filename and basic array specifications of a microengraved array 100, and then returns pixel intensity and quality control metrics for each feature in the array 100 with no human interaction, as shown by FIG. 1. The output of a microengraving process is an image file, for example, a tagged image file format (TIFF) image, that contains a fluorescent image of the array 100 for each analyte (analyte channels) and one image for the molecule included in the media (immunoglobulin G (IgG) or a specific cytokine) to define the locations of each well (registration channel). The process initially estimates the global rotation of the major axes of the array 100 (x- and y-axes) and then straightens the image with respect to each axis. The nominal location of each block is next registered to the image using a code that distinguishes each block geometrically. Lines delineating a grid on the array 100 are then adaptively drawn between blocks. The sub image for each feature in the delineated blocks is iteratively clustered to define the foreground area. A process for quality control is then applied to the image of each feature to identify pixels containing artifacts. Finally, the signal intensity, variance, and quality of the background and foreground pixels in each feature is extracted and returned in a tabular format along with images of each feature. Batched processes for multiple files can be implemented to allow the analysis of tens of arrays overnight with no human intervention.

FIG. 1. shows a schematic outline of modules in the first exemplary embodiment. In a first module 110, an input image is initially rotated to make the major axes of the array 100 parallel to the edges of the image. The geometric code defining the identity of each block is then deciphered to register the array 100. An adaptive gridding process draws grid lines between the blocks of the array 100 in a second module 120. The location of each feature is then identified using iterative k-means clustering of the registration channel image by a third module 130. In a fourth module 150, artifactual pixels in each analyte channel are removed using a combination of k-means clustering and a custom connectivity transform process to identify signals in the analyte channels and a geometric comparison of the identified signal across the array channels. In a fifth module 160, the intensities of non-artifactual pixels are extracted for analysis.

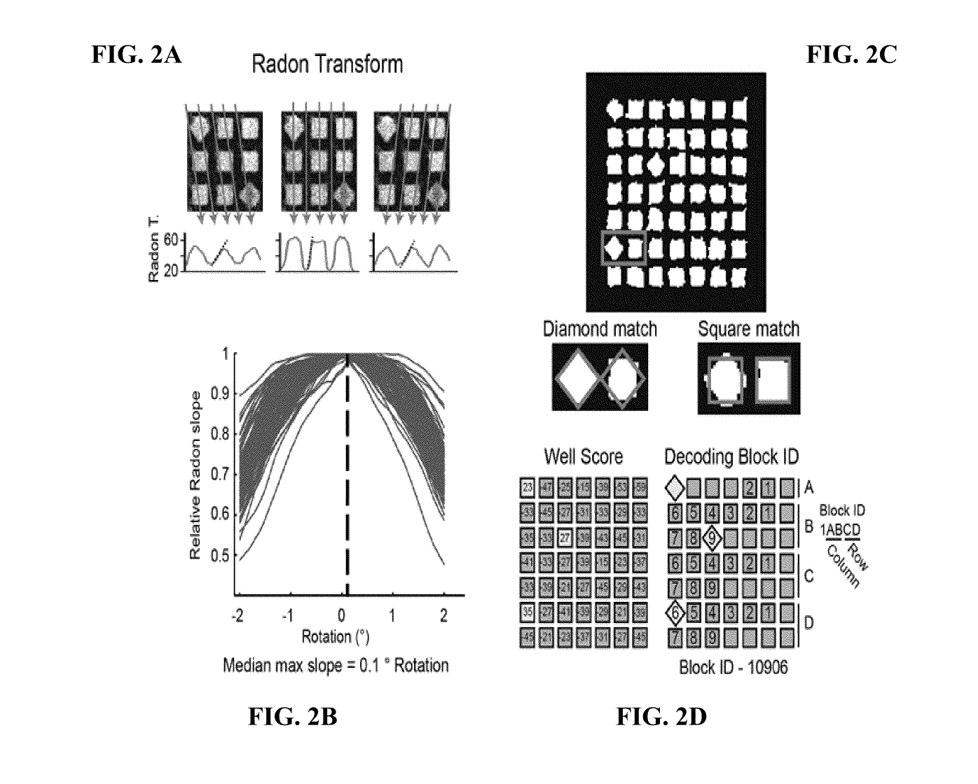

The initial module 110 in the first embodiment uses linear Radon transformations to estimate the rotation of the major axes of the array 100. The Radon transformation integrates the signal that a parallel set of vectors encounter crossing an image as the angle between the image and the vectors varies. FIG. 2A depicts representative Radon integrating vectors at three discrete angles (−10, 0 and 10°), and the resulting Radon transforms of the image at those angles. The slope of each radon transform curve is marked with a dotted line. When the Radon transform angle matches the rotation of the array 100, the slope of the transform between areas of high and low signal is maximized. For microengraved arrays, long-range, nonlinear distortions in the structure of the array and uneven signal sometimes make the Radon transform less accurate when applied to the whole image. The first embodiment, therefore, applies the transformation to many sub images containing two vertical blocks sampled from across the array 100. Each image is checked for the appropriate frequency of features to ensure the block images are of good quality.

The rotation of each sub image is then determined, as shown in FIG. 2B. Nearest neighbor interpolation is used to rotate the entire image by the median rotation angle of the sub images to yield an array 100 whose axes are aligned with the edges of the image.

After straightening the image, the location of each block in the array is registered to assign an identity to each block. Microengraved arrays often fade near the edges due to imperfect sealing. This effect can lead to misalignment of the entire grid when the identity of each block is defined using only the visible edges of the array. To overcome this issue, the arrays of nanowells employ an internal geometric code using diamond and square wells within each block; this code allows non-ambiguous identification of any isolated block. The first embodiment robustly deciphers these geometric codes. The process breaks the image of the array into overlapping, block-sized sub images. Each sub image is then tested for the appropriate frequency of features using 1-D projections along the x- and y-axes to identify sub images that contain an entire block. These sub images are transformed into binary images by rank ordering the pixels based on intensity and selecting the expected number of pixels with high intensities as positive. This estimated number derives from the specification passed by the user for the number and size of features in each block, as shown by FIG. 2C. Each individual feature is then aligned with a square and diamond template sized to fit the average feature size of the block. The number of negative pixels within each template is subtracted from the number of positive pixels in each template. The total from the diamond template is then subtracted from the total from the square template to yield the final feature score, as shown by FIG. 2D. A negative score for a feature identifies a square feature while a positive score identifies a diamond-shaped feature.

Once the feature scores are calculated for each sub image, they are used to identify the blocks present in each sub image. All blocks contain one diamond in the upper left-hand corner to establish the orientation of the array. The process initially identifies the corner feature that was most frequently identified as a diamond and then automatically flips the entire array 100 (and all sub images) to ensure proper orientation of the geometric code. The code is then deciphered using a lookup table. In this way, the process assigns a putative unique identifier to each block. The identity of each block with a valid block code is then corroborated using its spatial (x,y) location within the array 100 (FIG. 1) to estimate the location of the top left block. All blocks that yield a location within a distance of one-half the block pitch from each other are deemed correct and the locations of those blocks are used to register the remainder of the blocks in the array. The rates at which blocks were correctly identified by this process for several representative arrays are given in Table 1.

TABLE 1
Correct calling rates for process deciphering geometric block code.

| | | Valid Well | % |
|---|---|---|---|
| Total Blocks in Array | Identified Blocks | Codes | Correct Codes |
| 1728 | 1145 | 835 | 97.1 |
| 1728 | 1178 | 934 | 96.8 |
| 1728 | 1545 | 1246 | 97.0 |
| 602 | 294 | 94 | 90.4 |
| 602 | 489 | 200 | 86.5 |

The first exemplary process described above for registration gives sufficient information to locate all blocks in an ideal array by evaluating the inter-block distances. Occasionally however, these linear relationships may fail to correctly identify the precise location of blocks due to the nonlinear distortions in experimentally-derived arrays. A second exemplary process embodiment adaptively assigns the positions of blocks that monitors these distortions and ignores spurious and missing signals in parts of the array.

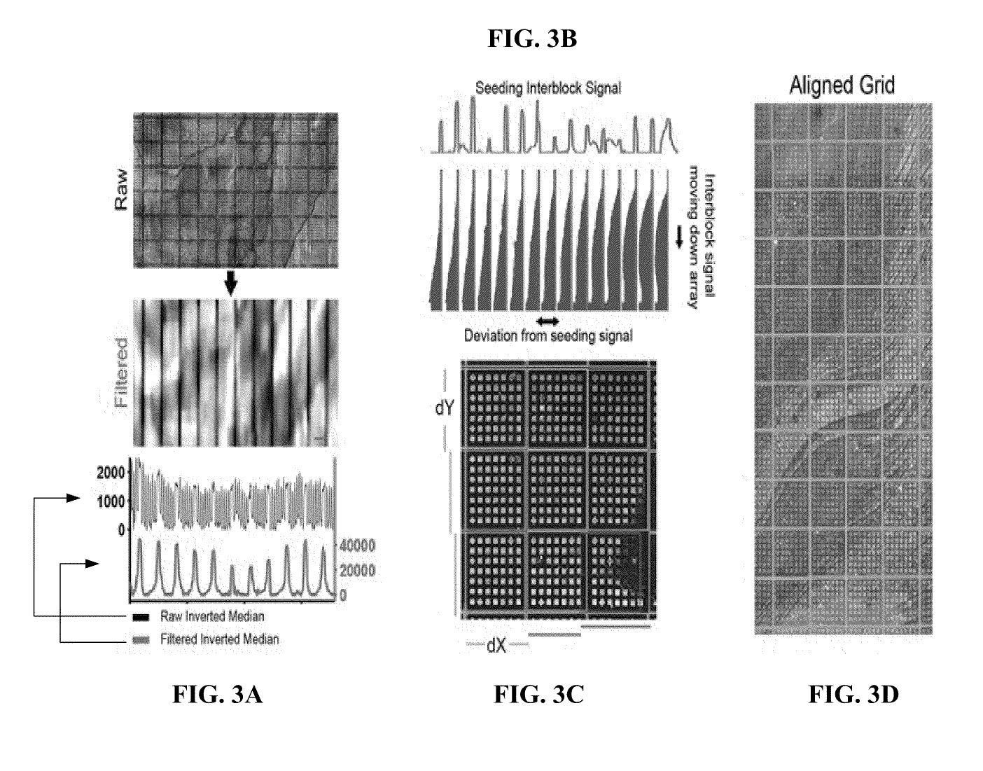

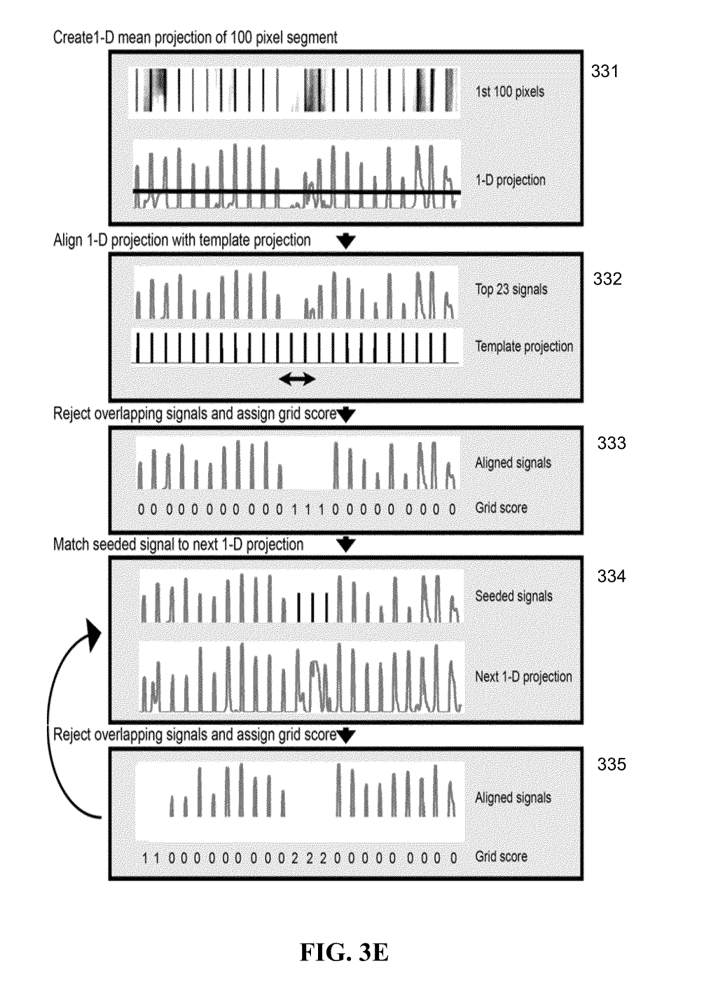

The second exemplary process begins by applying a series of bandpass filters to an array image to emphasize either the vertical or horizontal inter-block signals, as shown by FIG. 3A. The inter-block signal is then progressively monitored at regular intervals of a predetermined number of pixels, for example, every 100 pixels across the array using 1-D projections along the axis perpendicular to the emphasized signal.

FIG. 3A shows a raw image of an array and its transformation after passing through a series of low-pass filters designed to emphasize the inter-block vertical frequencies. 1-D projections of the raw and transformed images are displayed below the images. A 1-D projection based on the locations of blocks generated in the first process for registration establishes an initial template. This model projection is then shifted in relation to the actual 1-D projection of the first 100 pixels to find the location where the largest number of signals in the projection match the locations specified by the template. The movement is limited to a portion of the block pitch, for example 33% of the block pitch, to ensure the grid remains properly registered.

If half of all signals or a consecutive run of some of the signals, for example, 20% of the signals in the template match a signal in the projection, the location of each inter-block signal is seeded at the location of the template regardless of whether a signal was detected. If the two projections cannot be matched, the initial position of the template is used as the location on the array, and then the next 100-pixel region is examined. Once the inter-block signal is seeded, signals identified in further projections are aligned to the closest seed signal. If multiple signals align to the same seed signal, they are all discarded. If a signal is more than a predetermined amount, for example, 10 pixels away from any seed signal, it is also discarded as spurious signal since distortions of this magnitude over a 100-pixel distance have not been observed empirically in microengraved arrays.

If no signal matches a seed signal, the seed signal is carried forward to the next projection. Matched seed signals are replaced by the new signal location. This approach enables long range, nonlinear distortions in the array to be effectively monitored even if the distortions are not correlated across the array, as shown in FIG. 3B. The deviation from the initial inter-block signal used for seeding (top signal trace) is a function of the y position in the array. The x position of the initial seeding signal is drawn as the bottom signal trace. The x position of the actual signal at each y location in the array is noted by a horizontal bar.

To further increase the accuracy of the block positions, a metric for quality control measures the reliability of each grid line at each point in the array. As the grid lines are defined, a corresponding matrix keeps track of whether a signal for each line was detected in a given projection (see FIG. 3E).

When the location of each inter-block signal is initially seeded by the template, the quality metric for each line is set to zero. In subsequent alignments of the projection, if a signal is not detected, the metric for that line is increased by one. If a signal is detected, the total score decreases by two until zero is reached. The grid metric is used in two ways to increase the accuracy of the grid. First, neighboring grid lines are compared to each other. If the distance between the lines differs from the expected block distance by more than the feature pitch, the grid metric is used to adjust the less reliable grid line. The gridding process is also performed in both directions across the array (e.g. left-to-right and right-to-left) to avoid issues of poor signal on the edge of the array during grid seeding. The second use of the grid metric is to choose the best grid location when the grids drawn in opposite directions do not match.

As a further control for the quality of the aligned grid, the top left corner of each block is estimated using 1-D projections of the feature signals in the block areas defined by the grid lines. The corner of each block is then compared to neighboring blocks to make sure the block-to-block distance is within appropriate bounds, for example, less than 5%, as shown in FIG. 3C. The top left corner of each block is compared to the neighboring blocks. Blocks that are not correctly positioned are relocated using locations of a neighbor block.

Any block that is misaligned with neighboring blocks is realigned, creating a final grid of blocks. FIG. 3D shows an example of a final overlay for the blocks in an array. At the end of the process, each grid point has been assessed five different times, yielding a robust protocol for aligning a grid that automatically handles gross distortions in the array, large areas of missing signal, uneven backgrounds, and other artifacts that can occur in experimentally produced arrays.

FIG. 3E is a flowchart depicting the second embodiment. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The initial segment of pixels, for example, 100 pixels of the array, are transformed into a 1-D projection by averaging the pixel intensity along the axis perpendicular to the inter-block signals emphasized by the image transformation, as shown by block 331. An adaptive threshold is then used to select the strongest number of signals, n, where n is defined by the expected number of inter-block signals. The template projection generated in the registration process is then horizontally translated in relation to the 1-D projection to find the location where the maximal number of signals match the template within a smaller number of pixels, for example, 10 pixels, as shown by block 332. If enough signals are matched, the grid is seeded and the grid metric for each location is set to zero, as shown by blocks 333-334. Signals that match the same template signal or are greater than 10 pixels from any template signal are discarded along with neighboring signals. The grid metric for signal locations that lack a signal in this projection are increased by one. Locations that have a matching signal within 10 pixels are replaced by the location in the new projection. The new seeded signal template is then compared to the 1-D projection of the next 100 pixels in the image, as shown by block 335.

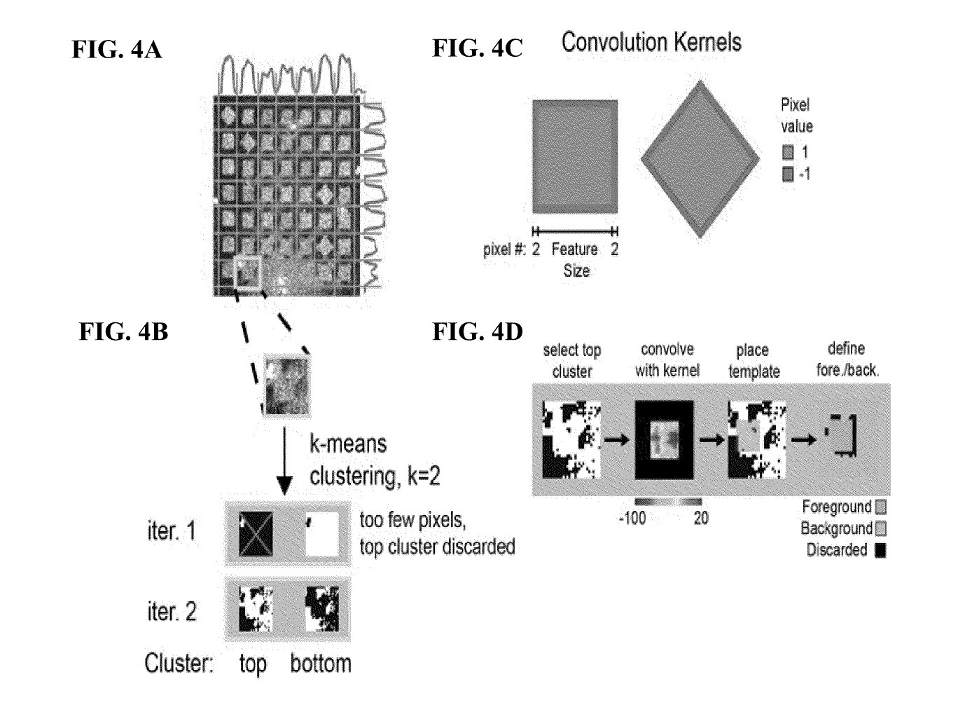

Once the location of each block is defined, features may be precisely located using a hybrid clustering/template method. A feature grid is created for each block using 1-D projections on each axis, as shown by FIG. 4A. A sample image of a block includes gridlines separating individual features. Lines dividing adjacent features may be drawn using the vertical and horizontal 1-D projections of the block image plotted along the top and right edges of the image.

K-means clustering is used to identify pixels in the foreground and background of each feature. FIG. 4B shows an example of iterative clustering of the pixels in the boxed-feature. The pixels are clustered based on both their intensities and the mean and variance of the surrounding pixels. The pixels in the cluster with the higher mean intensity in the first iteration are discarded due to the small size of the cluster. The top cluster in the second iteration contains enough pixels to encompass the feature and is used to create a binary image for convolution.

An initial analysis using data from a manually curated array is performed using different approaches known to persons having ordinary skill in the art to determine the optimal attributes of the data to use for clustering. The raw pixel intensities combined with neighboring pixel intensities generate foreground and background clusters that typically yield SNR values for the features that best match the manual curation. Including a preprocessing transformation of the data, location of the pixel in the feature image or a third cluster typically does not improve the resulting data.

An iterative approach may be applied to clustering because very bright artifact pixels may disrupt the identification of the foreground area when a single instance of clustering is used, as shown in FIG. 4B. The size of both clusters is compared to the nominal expected sizes of the foreground and background for a feature. If either is less than a third of the expected size, those pixels are discarded as either very bright or very dim artifacts that biased the clustering of the other pixels. The remaining pixels are re-clustered until the size criteria are met. In order to more accurately locate the feature, the final cluster with the higher mean pixel intensity is convoluted with a template kernel.

FIG. 4C shows graphical representations of the kernels used in the convolution with the top cluster. Each kernel contains a rim of 2 pixels with the value of −1 and all other internal pixels a value of 1. The size of the internal feature is defined by the average feature size of the array. The shape of the kernel is defined by the block code and known feature location; the size is defined by the average area of the feature calculated by the process while registering the array. The design of the kernel emphasizes the edges of the feature. The optimal location for the foreground is centered at the pixel that has the highest value in the convolution of the cluster and the kernel.

To account for features that differ in size from the average feature size, pixels in the top cluster that are within 2 pixels of the foreground area are excluded from further analysis to avoid potential foreground pixels contributing to background measurements and groups of negative pixels larger than 4 within the template are also excluded to account for smaller feature sizes, as shown in FIG. 4D. The binary image created by the iterative clustering process is convoluted with the correct kernel (second image, coded according to the convolution value of each pixel). The pixel with the highest convolution value is defined as the center of the feature and is used to position a template sized according to the average feature size of the array. The pixels within the template that are positive in the binary image are defined as foreground. Pixels within two pixels of the template that are positive or groups of negative pixels larger than 4 within the template are discarded. The remaining pixels are classified as background.

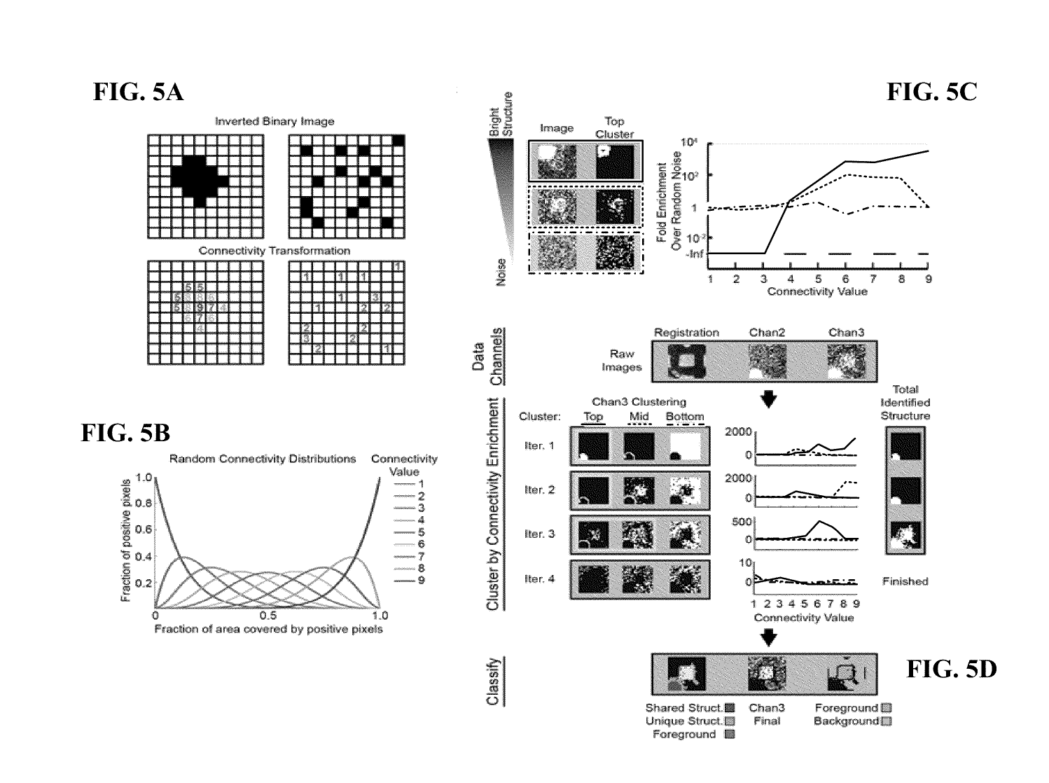

To improve the quality of the data extracted from each feature in the array, a third exemplary process embodiment implements an approach for automated identification of artifacts based on pixel intensity, location, and correlation between image channels. The module for removing artifacts begins by identifying structured pixels in each feature sub image. Structural identification is accomplished by a combination of k-means clustering (where k=3) and an image transformation that is referred to herein as a connectivity transformation. The connectivity transformation changes the values of positive pixels in a binary image to the connectivity value of the pixels, or the number of positive pixels any given pixel is touching including itself in our implementation. FIG. 5A shows examples of binary images and their connectivity transforms. Each positive pixel receives a value that is the sum of the number of adjacent positive pixels and itself. The frequency of each connectivity value in a given cluster is then determined, thereby providing a simplified description of the proximity of the pixels to each other in the cluster.

FIG. 5B shows plots of the expected fraction of positive pixels in a binary image with a particular connectivity value based on random noise as a function of the fraction of positive pixels in the image. The expected frequencies of connectivity values for random noise depend on the fraction of the available space occupied by positive pixels. The more space taken up by positive pixels, the more pixels touch each other. To determine whether the pixels in a cluster are part of a defined structure, the frequency of each connectivity value is compared to the frequency expected from random noise (given the same fraction of space covered by positive pixels).

The presence of structured pixels in the image leads to an enrichment of high connectivity values (traces 6-9) compared to noise. FIG. 5C shows examples of three types of images, their top ranked clusters determined by k-means clustering and the enrichment of connectivity values in each cluster relative to random noise. The plot line of the enrichment in the connectivity values corresponds to the box line surrounding each image. Clusters derived from images with bright structures are enriched in high connectivity values and depleted of low connectivity values relative to random noise, as shown by the solid line. Weak or diffuse structures show a modest enrichment in high connectivity values, as shown by the dashed line, and clusters from apparent noise show little to no enrichment in any values over expected values, as shown by the dot-dash line. Thus, the connectivity curves have characteristic traits for different structures and can indicate the type of structure present in the cluster (bright, dim, noise).

FIG. 5D illustrates the process used to remove artifacts. The registration channel and two analyte channels for the same feature are displayed in the top box. Beneath, the iterative clustering of Channel 3 is depicted. The binary images of the three clusters created by k-means clustering of the pixels based on their intensities and their neighbors' intensities are displayed for each iteration. The enrichment in connectivity values over random noise for each cluster is plotted next to the binary images. The structure removed in each iteration combined with the previous iterations is displayed next to the enrichment plots. In the first iteration, the first binary image is defined as structure. In the second iteration, the first binary image is defined as structure. In the third iteration, the first and second binary images are defined as structure. Clustering is terminated when no cluster is significantly enriched in connectivity values relative to noise. The first image in the bottom box of FIG. 5D overlays pixels that were identified as structure in both analyte channels, as structure only identified in Channel 3 and as defined foreground area. The second image depicts Channel 3 with the pixels designated as artifact removed. The third image displays the final foreground and background of this feature.

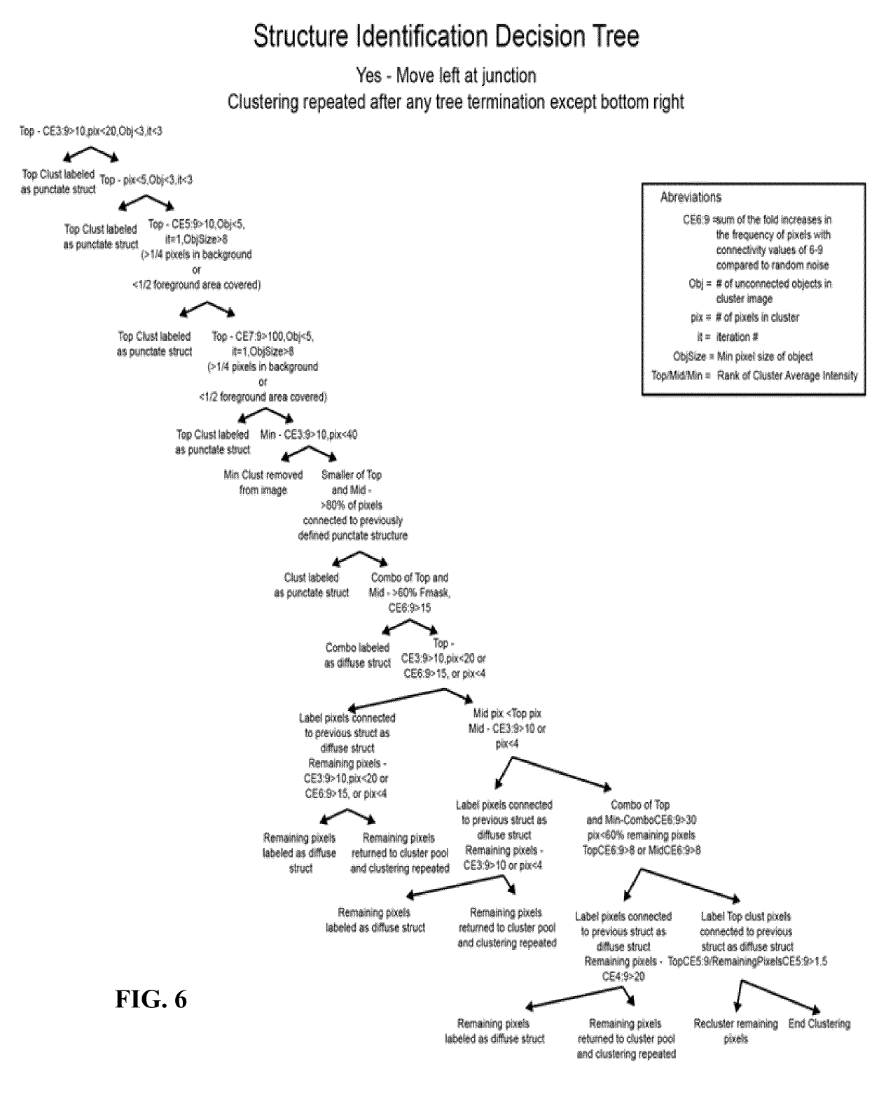

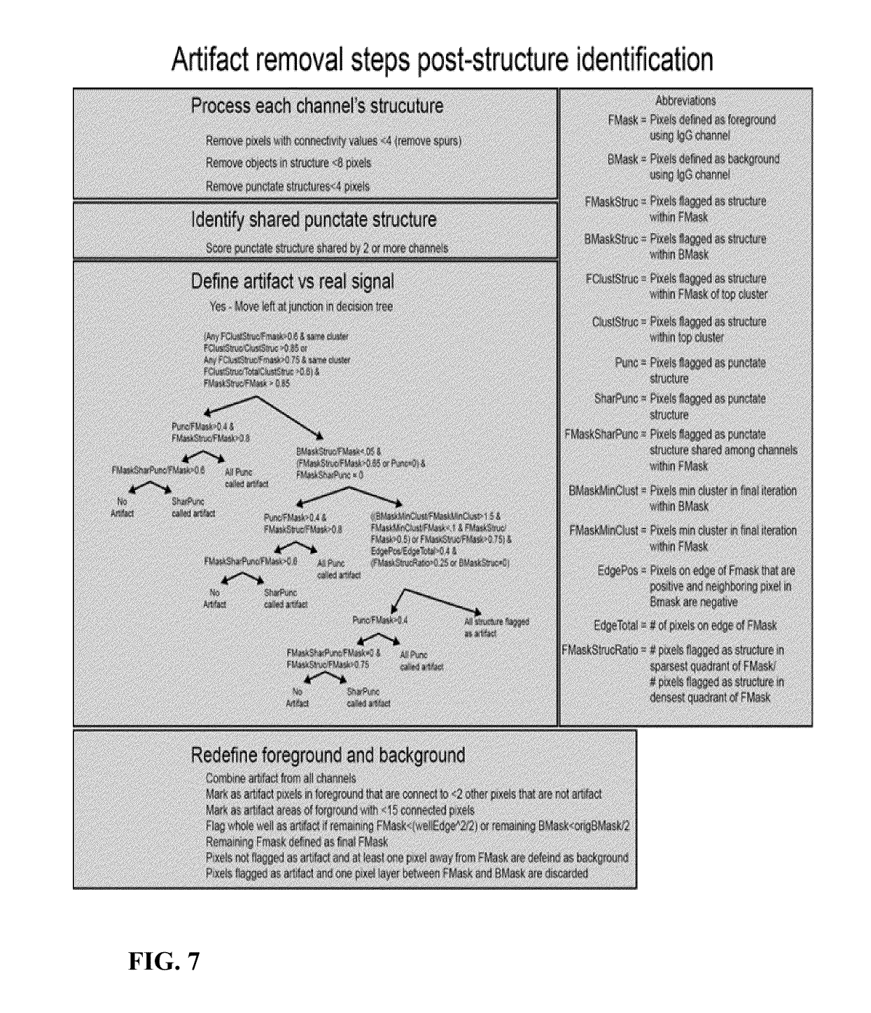

The third embodiment uses the geometric location of structured pixels within each image to identify artifacts. Each image channel is iteratively clustered for three groups of pixels using the pixel intensity and those of its neighbors. The enrichment of the connectivity value for each cluster and the combination of the top and middle cluster is then determined. The process progresses from the brightest cluster to the dimmest cluster, classifying each as noise, diffuse structure, or punctate structure based on the connectivity enrichment, as shown by FIG. 6. If a structure is found in a cluster, the pixels are labeled as the appropriate type of structure and removed from the analysis. The remaining pixels are re-clustered until no cluster has enrichment values significantly different from noise. Once all channels have been analyzed, the structure in each channel is compared to the previously identified foreground, as shown by FIG. 7. Punctate structure that occurs in multiple analyte channels and does not match the foreground area is labeled as shared punctate artifact, and removed from further analyses. Several geometric criteria are then used to compare the remaining structure to the shape of the foreground area. If the structure covers a defined amount of the foreground pixels and does not cover more than a defined amount of background pixels surrounding the foreground area, the structure covering the foreground area is retained in the image and the structured background pixels are defined as artifact and excluded from further analysis. If the number of structured background pixels surrounding the foreground area surpasses a set threshold, all structured pixels are defined as artifact. The exact levels for these cutoffs that are implemented are given in FIG. 7. These thresholds can be adjusted, however, depending on typical array performance. After removing structured artifacts, a ring of two pixels around the foreground area is also discarded to ensure no transition pixels are included in the background pixels. Once the foreground and background pixels are set, pixel intensities and other relevant metrics are extracted for each feature and exported in tabular form along with a file containing each feature sub image for downstream analysis.

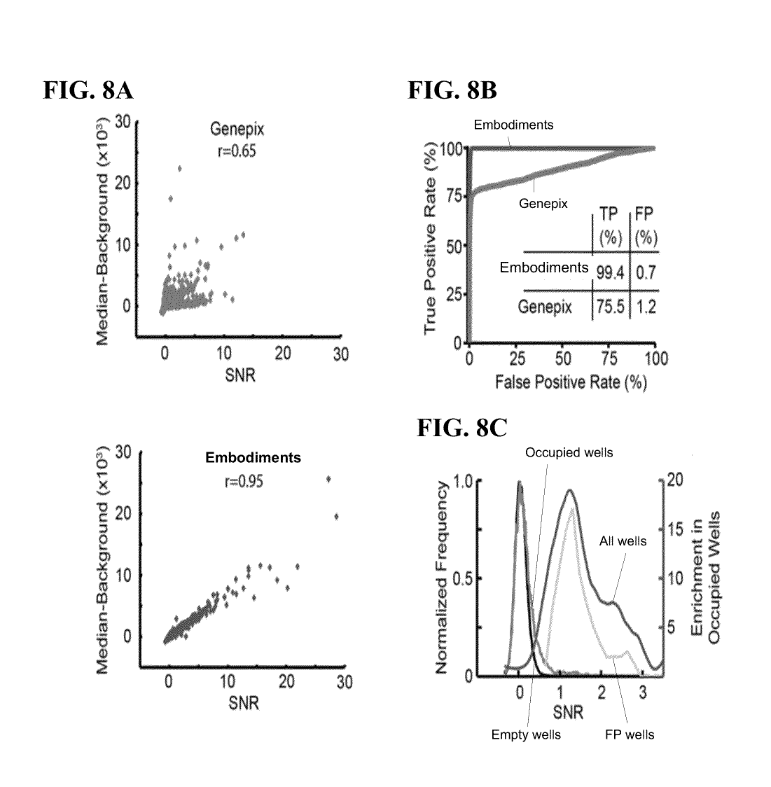

FIGS. 8A-8C illustrate a comparison of extracted data generated by the abovementioned embodiments with prior methods. In order to analyze the quality of the data produced by the abovementioned embodiments, the commercial software Genepix was used to analyze the same image of a protein microarray. An array of nanowells was loaded with HT29 cells and used for microengraving for one hour on a glass slide coated with capture antibodies for chemokine (C-X-C motif) ligand 1 (CXCL1) and chemokine (C-X-C motif) ligand 8 (CXCL8), as well as human IgG present in the media to mark the location of each well. After one hour, the slide was stained with fluorescent detection antibodies for each analyte and imaged with a four-laser fluorescent scanner to measure each detection antibody. The array of nanowells was also imaged after microengraving to determine the number of cells in each nanowell. Manual review of each feature for a positive signal in each analyte channel was used as the gold standard for identifying positive features. The image file path was processed using the abovementioned embodiments, and the data for all features was automatically exported with no human input. For comparison, data was extracted from the same image with Genepix after manual adjustment of the locations of blocks. SNR values and the median-background values extracted by using the exemplary embodiments demonstrate a much stronger correlation than the data extracted by Genepix (r=0.95 vs. r=0.62), as shown by FIG. 8A. This increase in data quality yielded a significant improvement in the true positive and false positive rates of SNR values output from the dataset shown in FIG. 8B.

To further analyze the rate of false positives called, the SNR values were grouped according to whether the corresponding nanowell was occupied during microengraving. Features corresponding to unoccupied nanowells represent the distribution of negative events. When the SNR values from nanowells containing cells was compared to the unoccupied wells, there was a significant enrichment in features with high SNR values, corresponding to measurable events of secreted analytes.

FIG. 8C illustrates the distribution of SNR values of features that contained cells or were empty during microengraving. The fold enrichment in occupied wells of all wells or wells defined as false positive by manual annotation with a given SNR value is also plotted.

It should be noted the features defined as false positive events by the receiver operating characteristic (ROC) curve in FIG. 8B (according to the manually curated dataset) may also be enriched in occupied wells, suggesting many of these events classified as false positive may in fact be true positive events not readily recognized by visual inspection due to low signal. Therefore, the rate of false positives may be significantly less than the estimate based on manual annotation. Therefore, the present invention may lead to an increase in sensitivity to secretion events over manual annotation of images of microengraved arrays.

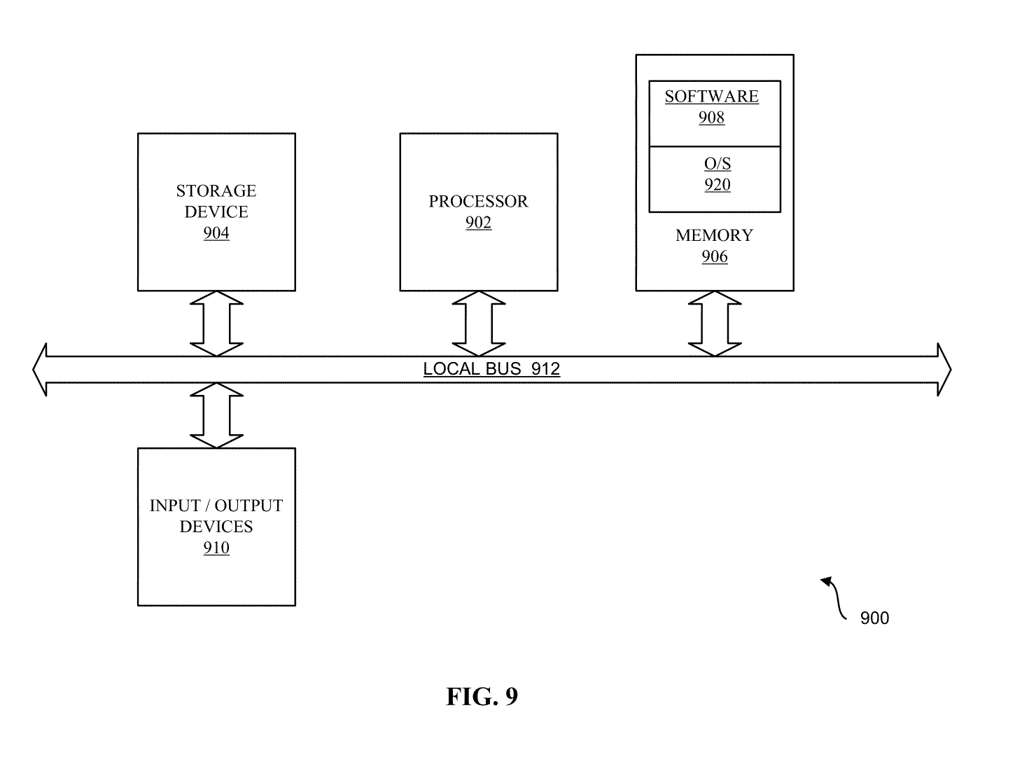

As previously mentioned, the present system for executing the functionality described in detail above may be a computer, an example of which is shown in the schematic diagram of FIG. 9. An example of a general purpose computer 900 that can implement the present system and method is described hereafter.

Generally, in terms of hardware architecture, the computer includes a processor 902, memory 906, storage device 904, and one or more input and/or output (I/O) devices (or peripherals) 910 that are communicatively coupled via a local interface 912 or bus. The local interface 912 can be, for example but not limited to, one or more buses or other wired or wireless connections, as is known in the art. The local interface 912 may have additional elements, which are omitted for simplicity, such as controllers, buffers (caches), drivers, repeaters, and receivers, to enable communication. Further, the local interface 912 may include address, control, and/or data connections to enable appropriate communications among the aforementioned components.

The processor 902 is a hardware device for executing software, particularly that stored in the memory 906. The processor 902 can be any custom made or commercially available processor, a central processing unit (CPU), an auxiliary processor among several processors associated with the computer 900, a semiconductor based microprocessor (in the form of a microchip or chip set), a macroprocessor, or generally any device for executing software instructions.

The memory 906 can include any one or combination of volatile memory elements (e.g., random access memory (RAM, such as DRAM, SRAM, SDRAM, etc.)) and nonvolatile memory elements (e.g., ROM, hard drive, tape, CDROM, DVD, flash memory, solid-state memory, etc.). Moreover, the memory 906 may incorporate electronic, magnetic, optical, and/or other types of storage media. Note that the memory 906 can have a distributed architecture, where various components are situated remote from one another, but can be accessed by the processor 902.

The software 908 in memory 906 may include one or more separate programs, each of which contains an ordered listing of executable instructions for implementing logical functions of the system 900, as described above. In addition, the memory 906 may contain an operating system (O/S) 920. The operating system essentially controls the execution of computer programs and provides scheduling, input-output control, file and data management, memory management, and communication control and related services.

Instructions for implementing the system 900 may be provided by a source program, executable program (object code), script, or any other entity containing a set of instructions to be performed. When a source program, the program needs to be translated via a compiler, assembler, interpreter, or the like, which may or may not be included within the memory 906, so as to operate properly in connection with the operating system 920. Furthermore, instructions for implementing the system 900 can be written as (a) an object oriented programming language, which has classes of data and methods, or (b) a procedure programming language, which has routines, subroutines, and/or functions.

The I/O devices 910 may include input devices, for example but not limited to, a keyboard, mouse, touch screen, scanner, microphone, other computing device, etc. Furthermore, the I/O devices 910 may also include output devices, for example but not limited to, a printer, display, etc. Finally, the I/O devices 910 may further include devices that communicate via both inputs and outputs, for instance but not limited to, a modulator/demodulator (modem; for accessing another device, system, or network), a radio frequency (RF) or other transceiver, a telephonic interface, a bridge, a router, etc.

When the functionality of the system 900 is in operation, the processor 902 is configured to execute the software 908 stored within the memory 906, to communicate data to and from the memory 906, and to generally control operations of the computer 900 pursuant to the software 908. The operating system 920 is read by the processor 902, perhaps buffered within the processor 902, and then executed. When the system 900 is implemented in software 908, it should be noted that instructions for implementing the system 900 can be stored on any computer-readable medium for use by or in connection with any computer-related device, system, or method. Such a computer-readable medium may, in some embodiments, correspond to either or both the memory 906 or the storage device 904. In the context of this document, a computer-readable medium is an electronic, magnetic, optical, or other physical device or means that can contain or store a computer program for use by or in connection with a computer-related device, system, or method. Instructions for implementing the system 900 can be embodied in any computer-readable medium for use by or in connection with the processor or other such instruction execution system, apparatus, or device. Although the processor 902 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 900 is implemented in hardware, the system 900 can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The abovementioned embodiments provide a comprehensive process for fully automated extraction of accurate data from images of microengraved protein arrays irrespective of spatial distortions to the array and aberrations in signal common in experimentally-produced arrays. The major approach used to improve the robustness of the process was to create multiple redundancies in the gridding process. The location of each block is interrogated five times by the process, and each feature relies on three separate techniques to assign the most accurate location. The ability to effectively combine information provided by multiple approaches through appropriate hierarchies, and numerical metrics for the quality of the aligned grid yields accurate registration and definition of features.

The automated registration of the array based on the geometric encoding of identity for each block is also a critical advance in automated analysis as it enables robust alignment and analysis of arrays in the presence of gross defects (e.g. blocks missing at the edges of the array). Although the geometric code is a unique result of the microengraving process, spotted arrays could employ a similar approach with the location of blocks or subarrays encoded by features lacking a spotted analyte. Overall, the abovementioned embodiments reduce a process for extracting data that often takes 1-2 hours of manual adjustment and annotation per array using existing software such as Genepix to 5 minutes of user time, thereby greatly expanding the number of arrays that can be feasibly analyzed by a single user.

The availability of cheap computing power provides opportunities to improve the quality of the data extracted from the arrays. First, fully automating the image analysis in itself improves data quality by removing user variability from the analysis. Second, the hybrid clustering/template matching approach used to define feature locations provides a more accurate fit of the foreground area than either approach alone, and thus should reduce the variance of the extracted data. Finally, the establishment of a flexible framework for identifying artifactual pixels within the image should also substantially improve the quality of data.

One powerful approach to identify certain artifacts, particularly in protein arrays, is the comparison of signal across different channels of data. Dust and other debris often cause bright fluorescent signals that are present in most, if not all, channels of a multi-channel array. This class of artifact in microengraved arrays can be readily identified by its connectivity enrichment pattern and their presence in multiple channels, allowing the process to confidently remove these pixels from the analysis. Inclusion of a scanned channel with no corresponding analyte makes this approach even more robust as it would eliminate any discrepancies when the artifact closely matches the foreground shape. This modification would also make this metric for quality control useful for arrays containing significant signal in all image channels (such as DNA microarrays). The segregation of the remaining structured pixels into signals arising from artifacts and analytes is accomplished by a set of criteria for geometric comparisons established predominately by empirical testing. These criteria may be further refined using machine learning processes to systematically optimize them. The simple yet accurate description of the image structure by nine connectivity enrichment values combined with pixel location information should enable easy adaptation of iterative processes to improve enumeration of artifact. Intensive analysis of raw images prior to data extraction through the use of newly developed capabilities for parallel computational processing such as implemented herein, represents a major opportunity for improving the quality of data culled from protein microarrays or other image-intensive bio molecular assays such as next-generation sequencing (NGS).

A supplementary microengraving method is also disclosed. A 1 mm thick polydimethylsiloxane (PDMS) device containing an array of 50×50×50 μm sized wells was produced using a custom-built injection mold as previously published. HT29 cells were suspended by trypsinization and dispensed into the array in DMEM media containing 10% FBS and 1:2500 dilution of human serum. The device was sealed against a polylysine-coated microscope slide bearing capture antibodies for CXCL8, CXCL1, and human immunoglobulin G (IgG), applied to the slide prior to use using a solution of 20 μg/mL followed by blocking in 3% milk solution. The sealed array was incubated at 37 C for 1 hour. The slide was removed and stained with 1 μg/mL detection antibodies labeled in house with Alexa Fluor 488, Alexa Fluor 594 and Alexa Fluor 700 (Life Technologies) respectively. The slide was imaged using a Genepix 4400 fluorescent scanner (Molecular Devices, Sunnyvale, Calif.). The cells in the array of nanowells were stained with the viability dye calcein violet AM and the dead cell dye Sytox Green and were imaged using an automated epifluorescent microscope (Zeiss Axiobserver Z1).

The abovementioned embodiments may be implemented in software, for example using Mathworks MATLAB code. The MATLAB implementation includes two executable files produced by MATLAB Compiler. To run the process, a batch file containing the path to one or multiple files containing images of arrays and information about each array structure may be passed to the first executable, which defines the location of each feature on the array. The first executable uses MATLAB Parallel Computing Toolbox to enable processing on up to 12 local CPU cores to decrease computing time. Once the locations are defined, the first executable distributes the artifact removal and data extraction steps, for example, over a cluster of three dual 6-core Xeon CPUs with Hyper-Threading, using the Microsoft Windows HPC Server 2008 R2 job scheduling environment in a parametric sweep. Each of these 72 virtual cores may receive the locations of all features in a row of blocks (up to 72 rows for a typical design of the array of nanowells) and use the second executable located on a shared network path to identify and remove artifacts and define the intensity values for each feature. The data extracted from all features in a row may be saved to a shared folder. The first executable may then compile the information from all cores and outputs the final data spreadsheet and images.

While the embodiments above generally refer to protein arrays, the scope of the claimed invention is not limited to protein arrays or protein array images. The embodiments are applicable to arrays beyond protein arrays or other types of images. For example, the artifact removal approach is applicable to NGS type images.

In summary, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for providing fully automated image segmentation and quality control of a protein array with no human interaction; comprising:
a memory; and
a processor configured by the memory to perform the nontransient steps of:
receiving an image file of the protein array;
geometrically distinguishing a first block within the image;
registering a nominal location of the first block to the image by assigning a geometric code identifying the first block;
adaptively drawing a plurality of grid lines on the array to delineate the first block from a second block;
iteratively clustering a sub image for each feature in the delineated blocks to define a foreground area and a background area; and
extracting and returning the signal intensity, variance, and quality of background and foreground pixels in each feature.

2. The system of claim 1, wherein the protein array comprises a microengraved array.

3. The system of claim 1, wherein the location of each feature is identified using iterative k-means clustering of the registration channel image.

4. The system of claim 1, wherein the input image file comprises a tagged image file format (TIFF) file.

5. The system of claim 1, wherein the input image file comprises a fluorescent image of the array for at least one analyte and one image for an included molecule to define a location of at least one well.

6. The system of claim 1, wherein the processor is further configured by the memory to perform the step of processing a batch of multiple image files.

7. The system of claim 1, wherein the processor is further configured by the memory to perform the steps of:
estimating a global rotation of an axis of the array; and
straightening the image with respect to the axis.

8. The system of claim 1 wherein signal intensity, variance, and quality of the background and foreground pixels in each feature are returned in a tabular format along with images of each feature.

9. The system of claim 1, wherein the step of identifying pixels containing an artifact for each feature further comprises identifying structured pixels in a sub image of each feature.

10. The system of claim 1, wherein the processor is further configured by the memory to perform the step of identifying pixels containing an artifact for each feature.

11. A system for adaptively assigning positions of blocks in a protein array image to monitor distortions and/or ignore spurious and missing signals in parts of the protein array image, comprising:
a memory; and
a processor configured by the memory to perform the nontransient steps of:
applying a bandpass filter to the array image to emphasize the vertical or horizontal inter-block signals;
using a first one dimensional projection along an axis perpendicular to the emphasized signal to monitor the inter-block signals of a predetermined number of pixels;
aligning the first one dimensional projection with a template projection;
rejecting overlapping signals;
assigning a grid score; and
matching a seeded signal to a second one dimensional projection.

12. The system of claim 11, wherein the template projection comprises a one dimensional projection based on the locations of blocks generated by registering the protein array image.

13. The system of claim 12, wherein the processor is further configured by the memory to perform the step of shifting the first one dimensional projection to find a location where the largest number of signals in the projection mate locations specified by the template.

14. The system of claim 13, wherein shifting the first one dimensional projection is limited to 0-33% of a block pitch.

15. A system for identifying and removing artifacts within a plurality of feature sub images of a protein array image, comprising:
a memory; and
a processor configured by the memory to perform the nontransient steps of:
identifying structured pixels in each feature sub image by applying k-means clustering to identify pixel clusters in the foreground and background of each feature and applying a connectivity image transformation.

16. The system of claim 15, wherein the processor is further configured by the memory to perform the steps of:
ordering the clusters from brightest to dimmest; and
starting at the brightest cluster and proceeding progressively toward the dimmest cluster.

17. The system of claim 15, wherein the connectivity image transformation further comprises changing the value of positive pixels to a connectivity value of the pixels.

18. The system of claim 17, wherein the connectivity value of a pixel comprises a sum of adjacent positive pixels including itself

19. The system of claim 18, wherein the processor is further configured by the memory to perform the step of comparing a frequency of each connectivity value to an expected frequency of random noise.
